(19) United States
(12) Patent Application Publication
(10) Pub. No.: US 2025/0133636 A1
(43) Pub. Date: Apr. 24, 2025

(54) DIMMING CONTROL SYSTEM FOR A LIGHT EMITTING ARRANGEMENT

(71) Applicant: SIGNIFY HOLDING B.V., EINDHOVEN (NL)

(72) Inventor: HENRICUS MARIUS JOSEPH MARIA KAHLMAN, DONGEN (NL)

(21) Appl. No.: 18/833,962

(22) PCT Filed: Jan. 26, 2023
(86) PCT No.: PCT/EP2023/051870

§ 371 Date: Jul. 29, 2024

(30) Foreign Application Priority Data
Feb. 1, 2022 (EP) 22154472.9

(51) Int. Cl. H05B 45/10; H05B 45/325; H05B 45/375

(52) U.S. Cl. CPC H05B 45/10; H05B 45/325; H05B 45/375

(57) ABSTRACT

A mechanism for controlling a dimming level of a light emitting arrangement. During initial dimming, the dimming level is controlled by controlling a maximum amplitude of current that can be drawn by any light emitting modules of a light emitting arrangement. During higher levels of dimming (for lower light intensities), the dimming level is controlled using a pulse width modulation strategy.

### FIELD OF THE INVENTION

The present invention relates to the field of light emitting arrangements, and in particular, to controlling the dimming of light emitting arrangements.

### BACKGROUND OF THE INVENTION

There is an increasing use of lighting in commercial, domestic and healthcare environments. One growing trend is the adoption of dimmable light emitting arrangements, which allow an individual to control or define an (average) intensity of light output by the light emitting arrangement. This advantageously allows for an individual to control light intensity to suit environmental needs their own desires, e.g., responsive to ambient light conditions.

Approaches that improve the dimming performance of light emitting arrangements are sought after. In particular, it would be advantageous to provide dimming techniques that can control an average intensity of light output by the light emitting arrangement without introducing (e.g., user-perceptible) flicker or ripple effects into output light.

### SUMMARY OF THE INVENTION

A basic idea of the invention is to use different dimming strategies for different desired dimming levels. During initial dimming, an amplitude control strategy is implemented, in which a maximum magnitude/amplitude of available current for any light emitting modules is modified responsive to a desired dimming level. When a dimming level reaches a predetermined dimming level, a pulse width modulation strategy is used to control the average available current for any light emitting modules. This provides an approach where the effective modulation depth during pulse width modulation is at a minimum, to reduce apparent flicker effects.

According to examples in accordance with an aspect of the invention, there is provided a dimming control system for controlling a dimming level of a light emitting arrangement comprising one or more light emitting modules, wherein: a dimming level defines an average current available to be drawn by the one or more light emitting modules and ranges from a minimum dimming level to a maximum dimming level, in which a minimum dimming level provides a greater average current available to be drawn by the light emitting modules than the maximum dimming level; and for each light emitting module, the average intensity of light output by the light emitting module is responsive to an average current drawn by each light emitting module.

The dimming control system is configured to control the dimming level by: for a first dimming range, which is bound by the minimum dimming level and a first predetermined dimming level, controlling the maximum amplitude of current available to be drawn by the one or more light emitting modules; for a second dimming range, which is bound on one side by the first predetermined dimming level, performing pulse width modulation of the current available to be drawn by the one or more light emitting modules, wherein performing pulse width modulation comprises iteratively performing cycles, each cycle including: a first period of time during which the dimming control system allows current to be drawn by the one or more light emitting modules, wherein the first period of time is fixed to a same predetermined length of time for each cycle; a second period of time during which the dimming control system prevents or restricts current from being drawn by the one or more light emitting modules, wherein, for each cycle, the dimming control system controls the length of the second period of time to control the average current available to be drawn by each light emitting module, wherein light output by the light emitting arrangement has a greater average intensity in the first dimming range than in the second dimming range.

Embodiments provide a mechanism for dimming a light emitting arrangement. A dimming control system is configured to control the dimming level of the light emitting arrangement. For a first dimming range, the dimming control system controls the maximum amplitude of current that can be drawn by the dimming control system. This can be performed by control the operation of a power supply or power converter for the light emitting arrangement. For a second dimming range (in which light output by the light emitting arrangement is less than during the first dimming range), the dimming control system controls the average current that can be drawn by the dimming control system using pulse width modulation.

The advantage of this approach is reduced flicker during initial dimming of the light emitting arrangement. The proposed approach will also avoid introduction of any color shifting if the one or more light emitting modules comprise multiple light emitting modules that emit light of different colors, e.g., as the ratio between different color channels will be maintained during the dimming procedure.

Thus, in the second dimming range, the frequency of performing cycles of the pulse width modulation, i.e., the modulation frequency, will change dependent upon the dimming level.

In some examples, the dimming control system is configured to control the dimming level by, for a third dimming range: maintaining the frequency of performing cycles of the pulse width modulation at a predetermined frequency; and controlling, for each cycle of the pulse width modulation, the length of the first period of time and the second period of time to thereby control the average current available to be drawn by each light emitting module, wherein the second dimming range is bound by the first predetermined dimming level and a second predetermined dimming level and the third dimming range is bound by the second predetermined dimming level and the maximum dimming level.

The predetermined frequency may be between 0.5 kHz and 5 kHz. For instance, the predetermined frequency may be 1 kHz.

In some examples, the minimum frequency of performing cycles of the pulse width modulation during the second dimming range is no less than the predetermined frequency.

For instance, the predetermined length of time may be between 5 μs and 50 μs. Preferably, the predetermined length of time is between 10 μs and 50 μs, e.g. between 15 μs and 50 μs. The predetermined length of time may be 25 μs.

Optionally, the dimming control system is configured to prevent or restrict current from being drawn by the one or more light emitting modules by activating a bypass switch that, when activated, provides a conductive path for current to bypass the one or more light emitting modules.

In some examples, the dimming control system is configured to prevent or restrict current from being drawn by the one or more light emitting modules by activating an isolating switch that, when activated, isolates or disconnects the one or more light emitting modules from a power supply configured to provide current to the one or more light emitting modules.

In at least one example, the light emitting arrangement comprises a current controller configured to control a maximum amplitude of a current available to the one or more light emitting modules; and for the first dimming range, the dimming control system controls the operation of the current controller to thereby control the maximum amplitude of current available to be drawn by the one or more light emitting modules.

In at least one example, the light emitting arrangement comprises a buck converter configured to provide current to the one or more light emitting modules; and for the first dimming range, the dimming control system controls the operation of the buck converter to thereby control the maximum amplitude of current available to be drawn by the one or more light emitting modules.

In some examples, for the first dimming range, the dimming control system, performs hysteretic control of the buck converter.

In at least one example, the dimming control system is configured to: receive a user input indicating a desired dimming level for the light emitting arrangement; and control the dimming level responsive to the desired dimming level.

There is also proposed a lighting arrangement comprising the dimming control system herein described and the light emitting arrangement comprising the one or more light emitting modules.

Optionally, each light emitting module comprises: one or more light emitting diodes connected in series; a capacitor connected in parallel with the one or more light emitting diodes; and a diode connected in series with the one or more light emitting diodes and the capacitor, wherein the diode is arranged to have an opposite polarity to the one or more light emitting diodes.

Preferably, each light emitting module comprises a module switch configured to control an average current drawn by the light emitting module.

In some examples, the one or more light emitting modules comprises a plurality of light emitting modules, and each light emitting module is configured to emit light of a different color and/or temperature.

The lighting arrangement may comprise the current controller, the bypass switch and/or the isolating switch previously described. The lighting arrangement may be configured to connect to a power supply that provides the current for the light emitting modules, e.g., a converted mains power supply.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a lighting arrangement;

FIG. 2 illustrates an approach for controlling a dimming level;

FIG. 3 illustrates another approach for controlling a dimming level;

FIGS. 4 and 5 illustrate an average current available for any light emitting modules during a dimming procedure; and

FIG. 6 illustrates the current available to be drawn by the light emitting module during various control strategies.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for controlling a dimming level of a light emitting arrangement. During initial dimming, the dimming level is controlled by controlling a maximum amplitude of current that can be drawn by any light emitting modules of a light emitting arrangement. During higher levels of dimming (for lower light intensities), the dimming level is controlled using a pulse width modulation strategy.

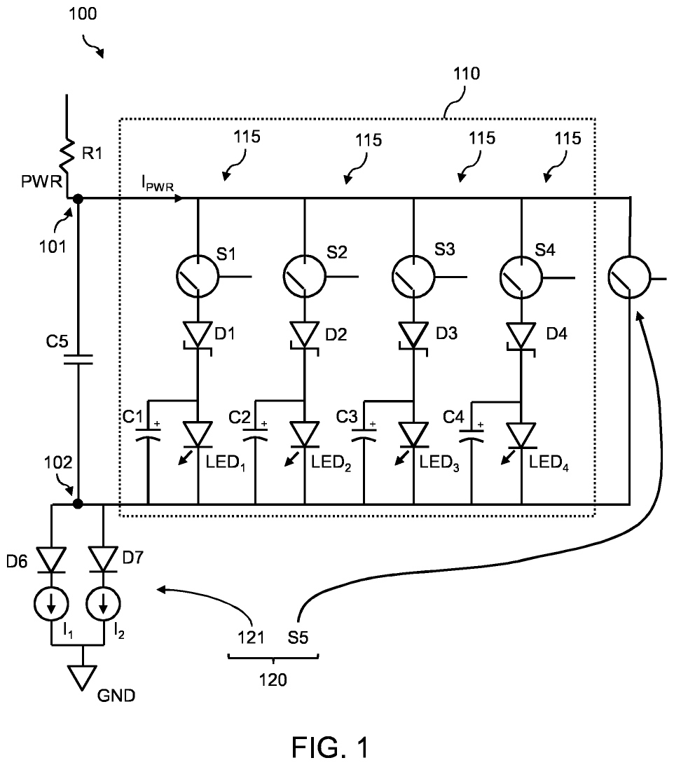

FIG. 1 is a circuit diagram illustrating a lighting arrangement 100 for use with an embodiment. The lighting arrangement comprises a light emitting arrangement 110 and a dimming control system 120. Other components of the lighting arrangement (e.g. a driving circuit and the like) may be present, but are not illustrated for the sake of conciseness.

The lighting arrangement 100 is powered by a power source (not shown), and is connected between a signal PWR provided by this power source and a ground/reference voltage GND. The signal PWR may be a DC power signal, e.g., a DC voltage signal.

The illustrated light emitting arrangement 110 comprises a plurality of light emitting modules 115 for emitting light. In the illustrated example, the light emitting modules 115 are connected in parallel to one another.

However, in other examples, the light emitting arrangement comprises only one light emitting module.

The light emitting module(s) may be connected between a first terminal 101, which receives the signal PWR from the power source, and a second terminal 102, which connects to the ground or reference voltage GND.

Each light emitting module 115 comprises one or more light emitting diodes (LEDs) LED₁, LED₂, LED₃, LED₄. An average magnitude of current flowing through the light emitting diode(s) of a light emitting module defines the intensity of light output by the light emitting module.

In particular, each light emitting module may be configured to selectively control an amount of current (of available current) that is drawn by the light emitting module, e.g. by controlling the operation of a module switch S1-S4 using pulse width modulation or similar techniques. Thus, each light emitting module may comprise a module switch S1-S4 configured to control an average current drawn by the light emitting module. The operation of the module switch(es) may be controlled by a module control system (not shown). The average amplitude of the current drawn by the light emitting module defines an average intensity of light output by the light emitting module.

Each light emitting module 115 may be configured to output light of a different color and/or temperature. In these scenarios, the overall apparent/effective color and/or temperature of light output by the lighting arrangement 100 is defined by the average intensity of light output by each light emitting module. In this way, the overall apparent/effective color and/or temperature of light output by the lighting arrangement 100 is defined by the average amount of current drawn by each light emitting module 115.

More specifically, the ratio(s) of current(s) drawn by different light emitting modules 115 will define the overall apparent/effective color and/or temperature of light.

For improved efficiency, it may be preferable for each light emitting module 115 to be preventing/restricted from drawing current at a same time as any other light emitting module 115 of the light emitting arrangement 110. Thus, each light emitting module 115 may be controlled to operate under a pulse width modulation scheme, in which it draws available current for only a part or proportion of time within iteratively performed control cycles. The ratio(s) between these proportions of time defines the overall apparent/effective color and/or temperature of light output by the light emitting arrangement 110. For improved efficiency, the sum of the proportion of times (within each control cycle) for all light emitting modules 115 may be equal to 1.

However, the skilled person would appreciate that it is not essential for each light emitting module 115 to have individual control over the current drawn by the light emitting module 115, e.g. the modules switches S1-S4 could be omitted and/or replaced by a direct circuit connection.

Similarly, it is also not essential for each light outputting module 115 to output light of a different color and/or temperature. In such embodiments, it may still be advantageous to prevent/restrict each light emitting module 115 from drawing current at a same time as any other light emitting module 115 of the light emitting arrangement 110.

It is possible to control an average intensity of light output by the light emitting arrangement 110 by controlling an average current I_{PWR} available to be drawn by the one or more light emitting modules 115 (“average available current”). More particularly, controlling the average available current may comprise controlling an average current between the first 101 and second 102 terminals to which the light emitting module(s) 115 are connected. This process may be performed by the dimming control system 120, e.g. responsive to a desired dimming level. This can be performed independently of the individual control of current drawn by each light emitting module 115 (if performed/present).

Controlling the current available to be drawn by the one or more light emitting modules 115 is functionally equivalent to controlling a dimming level of the light emitting arrangement 110. In particular, a maximum possible (average) current may be made available to be drawn for a minimum dimming level and a minimum possible (average) current may be made available to be drawn for a maximum dimming level. Intermediate dimming levels are defined by corresponding intermediate values for the average current available to the light emitting modules 115.

Thus, a dimming level is inversely proportional to an average available current for the light emitting module(s).

Conceptually, a dimming level could be seen as being inversely proportional to average light intensity output by the lighting arrangement 100. However, as the average current drawn by each light emitting module 115 may (in some embodiments) be individually controlled, this is not necessarily true for all light output scenarios. Conversely, it will be understood that for scenarios in which each light emitting module 115 draws a same amount of current, the dimming level is inversely proportional to average light intensity output by the lighting arrangement 100.

Broadly speaking, it is possible to define two approaches for controlling an average current available I_{PWR} to be drawn by the one or more light emitting modules 115, to thereby allow for control of a dimming level.

A first approach is to control the maximum or peak amplitude of the average current. This can be controlled by using a current controller 121 connected in series with each light emitting module 115, to define the maximum or peak magnitude of the available current to be drawn by each light emitting module. The current controller 121 forms part of the dimming control system 120.

The current controller 121 may be formed of a buck converter or the like.

Alternatively, the current controller 121 may be formed of a linear current regulator. Suitable current controllers will be apparent to the skilled person. The illustrated current controller 121 comprises two current control modules I₁, I₂ each connected in series with a respective diode D6, D7.

A second approach is to control, per unit time or time cycle, an amount of time that current is available to be drawn—e.g., using pulse width modulation techniques. The second approach could be performed by selectively bypassing the light emitting module(s) using a bypass switch S5 or similar, to restrict or prevent current being drawn by the light emitting module(s) 115. The bypass switch S5 would also form part of the dimming control system 120.

Proposed embodiments provide new control schemes for the light emitting arrangement 110 that comprises one or more light emitting modules, such as the light emitting arrangement 110 illustrated in FIG. 1. Some proposed embodiments also provide improvements to the light emitting arrangement 110.

In particular, proposed embodiments propose a new approach for controlling the operation of a light emitting arrangement 110 responsive to a desired dimming level.

For the purposes of understanding, a dimming level is considered to range from a minimum dimming level (MIN) to a maximum dimming level (MAX), e.g., using a predetermined numerical scale such as from 0 to 1. Other suitable scales for a dimming level could be used (e.g. 0-10, 0-63, 0-100, 1-10, 1-64, or 1-100).

TABLE 1

| Dimming Level | Control Strategy |
|---|---|
| From MIN to TH₁ | AMP |
| From TH₁ to MAX | PWM |

Table 1 illustrates a first control scheme for controlling a dimming of the light emitting arrangement 110. The first control scheme is carried out by the dimming control system 120.

In the first control scheme, an amplitude control strategy (AMP) is performed when a desired dimming level falls within a first dimming range (MIN to TH1). The first dimming range is bound by the minimum dimming level MIN and a first predetermined dimming level TH1.

The amplitude control strategy AMP comprises controlling the maximum amplitude of current available to be drawn by the one or more light emitting modules, e.g. the maximum amplitude of current between the first 101 and second 102 terminals. With reference to the light emitting arrangement 110 of FIG. 1, this can be performed by controlling the operation of the current controller 121.

In particular, for increasing dimming levels, the dimming control system 120 may reduce the maximum amplitude of current available to be drawn by the one or more light emitting modules 115 (and vice versa).

Where the current controller 121 comprises a buck converter configured to provide current to the one or more light emitting modules 115, the dimming control system 120 may be configured to control the operation of the buck converter to thereby control the maximum amplitude of current available to be drawn by the one or more light emitting modules 115, i.e., during the amplitude control strategy.

In particularly preferable examples, during the amplitude control strategy, the dimming control system 120 may be configured to perform hysteretic control of the buck converter. With this type of control, the buck converter can have an ultra-fast response.

During the amplitude control strategy, no pulse width modulation is performed.

In the first control scheme, a pulse width modulation strategy (PWM) is performed when the desired dimming level falls within a second dimming range (TH1 to MAX). The second dimming range is bound by the first predetermined dimming level TH1 and the maximum dimming level MAX.

The pulse width modulation strategy PWM comprises iteratively performing cycles, which includes a first period of time followed by a second period of time.

During the first period of time (of each cycle), the dimming control system allows current to be drawn by the one or more light emitting modules. The length of the first period of time is fixed to a same predetermined length of time for each cycle (i.e. for all dimming levels within the second dimming range).

The predetermined length of time may be between 5 μs and 50 μs. Preferably, the predetermined length of time is between 10 μs and 50 μs, e.g. between 15 μs and 50 μs. For instance, the predetermined length of time may be 25 μs. It has been recognized that these periods of time provide a good compromise between available dimming range and resolution for the different color/temperature channels (if present). For instance, experimental analysis has shown that if the predetermined length of time has a length of 25 μs, then a 12-bit resolution can be achieved.

Moreover, there is a transition time when switching from low/no current flow to high-current flow (i.e., the switch is not instantaneous). Usually, the length of this transition time is negligible compared to the length of the period of time for which current can flow in each cycle. However, with a decreasing predetermined length of time, then the transition time becomes increasingly dominant, affecting the accuracy of dimming at low dimming levels. By limiting the predetermined length of time to have a length no less than 5 μs, e.g., no less than 10 μs, this effect can be reduced.

During the second period of time (of each cycle), the dimming control system 120 prevents or restricts current from being drawn by the one or more light emitting modules 115. The dimming control system 120 is configured to control the length of the second period of time to control the average current available to be drawn by each light emitting module 115. In other words, the length of the second period of time will change for different dimming levels within the second dimming range.

In particular, for increasing dimming levels in the second dimming range, the dimming control system 120 may increase the length of the second period of time. For decreasing dimming levels in the second dimming range, the dimming control system 120 may decrease the length of the second period of time.

As previously explained, preventing or restricting current from being drawn by the one or more light emitting modules 115 can be performed by allowing current to bypass the light emitting modules 115, e.g., using a bypass switch S5.

Alternatively, the dimming control system may be configured to prevent or restrict current from being drawn by the one or more light emitting modules 115 by activating an isolating switch that, when activated, isolates or disconnects the one or more light emitting modules 115 from a power supply configured to provide current to the one or more light emitting modules 115. This isolating switch may be connected in series between the first terminal 101 and the light emitting module(s) 115 or between the light emitting module(s) and the second terminal 102.

Controlling the second period of time effectively controls the pulse width frequency of the pulse width modulation. The total ON time for the light emitting modules 115 is fixed for each cycle. The total ON time may for example be the total amount of time that current can be drawn by the light emitting module(s) 115 for each cycle. This reduces or avoids potential ripple and/or color shift of the light emitting arrangement 110.

During the pulse width modulation strategy, the maximum amplitude of current available to be drawn by the one or more light emitting modules 115 may be fixed. In particular, the maximum amplitude of current available to be drawn by the one or more light emitting modules 115 may be fixed to the lowest maximum amplitude for the current during the amplitude control strategy. This may for example be the maximum amplitude for available current at the first predetermined dimming level TH1.

The first control scheme is particularly advantageous for the light emitting arrangement 110 illustrated in FIG. 1, which includes some optional but advantageous features.

In a particular example, each light emitting module 115 of the light emitting arrangement 110 further comprises one or more capacitors C1, C2, C3, C4, e.g., a single capacitor, connected in parallel with the one or more light emitting diodes LED1, LED2, LED3, LED4. Each capacitor C1, C2, C3, C4 may be an electrolytic capacitor. Each light emitting module 115 also comprises a diode D1, D2, D3, D4 connected in series with the parallel arrangement of the one or more light emitting diodes and the corresponding one or more capacitors. For each light emitting module 115, the diode D1, D2, D3, D4 is arranged to have the same polarity as the one or more light emitting diodes LED1, LED2, LED3, LED4.

The use of the capacitor(s) C1, C2, C3, C4 acts to filter or smooth the effect of pulse width modulation on current flow through the light emitting diode of the light emitting module 115, e.g., pulse width modulation caused by the dimming control system 120 and/or the module control systems (not shown). A non-smoothed current flow would result in a flicker effect in light emitted by the light emitting diode e.g. due to the square-wave like nature of current resulting from PWM. The proposed use of a capacitor acts to make the current through the LED of the light emitting module 115 continuous with reduced ripple.

Thus, use of a capacitor in the light emitting diode reduces apparent flicker.

Put another way, the use of a capacitor in each light emitting module 115 reduces the 100% modulation depth in the light emitting module 115 that would result from PWM control of the light emitting module 115 and/or current made available to the light emitting module 115.

The diode D1, D2, D3, D4 prevents current from flowing from the capacitor C1, C2, C3, C4 to other parts of the light emitting module 115 without passing through the LED. This avoids leakage current, undesirable powering of other LEDs and improves efficiency.

As previously noted, the first control scheme is particularly advantageous for use in such a light emitting arrangement. In particular, the first control scheme allows a capacitor C1-C4 having a relatively small capacitance to be used in each light emitting module.

The precise value of the capacitor of the capacitors C1-C4 may depend upon a variety of factors, including a required (minimum) amplitude for LED currents, the dynamic resistance of the LED(s), the type of capacitor and the required/desired maximum allowable ripple for current through the LED(s) of the light emitting module 115. As a working example, a capacitor of 100 μF may be used as a good compromise for meeting such requirements for a standard or conventional set up.

By way of explanation, by first controlling dimming using the amplitude control strategy (i.e., for lower dimming levels), the amount of charge that needs to be stored by the capacitor for providing relatively smooth current during dimming controlled by a pulse width modulation strategy is relatively low. This is because the average current (and therefore amount of charge) that would need to be stored by the capacitor to smooth/filter the effect of the pulse width modulation strategy would be higher (due to the higher maximum amplitude of the current).

By contrast, if the pulse width modulation strategy was used at low dimming levels, then the amount of charge that would need to be stored by the capacitor to ensure a relatively consistent and smooth current through the LED(s) would be relatively high. This would necessitate a much larger capacitor compared to if the proposed control scheme is used.

The use of the capacitor in each light emitting module 115 allows the dimming level of the light emitting arrangement to be increased, using the pulse width modulation strategy, beyond a point where flicker would be otherwise noticeable/perceivable by an individual. In particular, without the capacitor, flicker may be noticed at low pulse width modulation frequencies, e.g. at frequencies less than 1 kHz. With the capacitor, this flicker is less perceptible at low frequencies (<1 kHz).

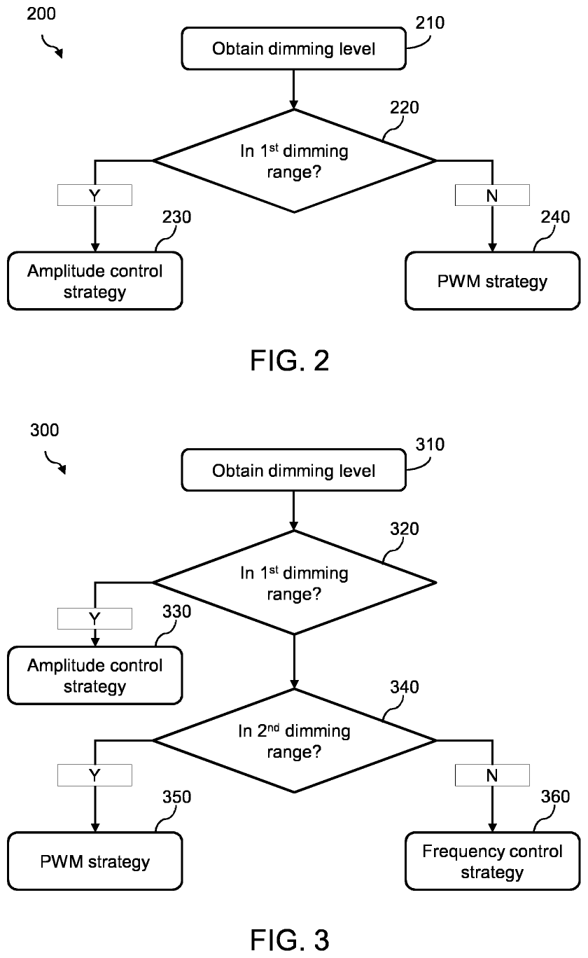

For the sake of completeness, FIG. 2 is a flowchart illustrating a method 200 that could be employed by the dimming control system to carry out the first control scheme.

The method 200 comprises a step 210 of obtaining a desired dimming level.

This may be obtained at an input interface of the dimming control system, e.g., receiving an input from a user interface and/or a communication module.

The method 200 then determines in a step 220 whether or not the desired dimming level falls within the first dimming range, i.e., falls between a minimum dimming level MIN and a first predetermined dimming level TH1 (inclusive).

Responsive to the desired dimming level falling within the first dimming range, the method performs a step 230 of controlling the light emitting arrangement according to the amplitude control strategy. Otherwise, the method performs a step 240 of controlling the light emitting arrangement according to the pulse width modulation strategy.

Reference is again made to FIG. 1.

Table 2 illustrates a second control scheme for controlling a dimming of the light emitting arrangement 110. The second control scheme is carried out by the dimming control system 120.

TABLE 2

| Dimming Level | Control Strategy |
|---|---|
| From MIN to TH₁ | AMP |
| From TH₁ to TH₂ | PWM |
| From TH₂ to MAX | FREQ |

In the second control scheme, the amplitude control strategy (AMP) is performed when the desired dimming level falls within a first dimming range (MIN to TH₁). The first dimming range is bound by the minimum dimming level MIN and a first predetermined dimming level TH₁. The operation of the amplitude control strategy has been previously described with reference to the first control scheme.

In the second control scheme, the pulse width modulation strategy (PWM) is performed when the desired dimming level falls within a second dimming range. For the second control scheme, the second dimming range is bound by the first predetermined dimming level TH₁ and a second predetermined dimming level TH₂. The first predetermined dimming level TH₁ is smaller than the second predetermined dimming level TH2. The operation of the pulse width modulation strategy has been previously described with reference to the first control scheme.

In the second control scheme, a frequency control strategy (FREQ) is performed when the desired dimming level falls within a third dimming range. The third dimming range is bound by the second predetermined dimming level TH₂ and the maximum dimming level MAX.

The frequency control strategy FREQ is similar to the pulse width modulation strategy in that it comprises performing pulse width modulation of the current available to be drawn by the one or more light emitting modules, wherein performing pulse width modulation comprises iteratively performing cycles.

However, the frequency control strategy FREQ comprises maintaining the frequency of performing cycles of the pulse width modulation at a predetermined frequency. This contrasts from the changing frequency in the pulse width modulation strategy.

The predetermined frequency may be no less than 0.5 kHz, e.g., no less than 1 kHz. If a space vector modulation (SVM) approach is used to control the operation of the light emitting module(s), then requirements for accurate space vector modulation are met or are not a significant issue when the predetermined frequency is greater than these values.

In some examples, the predetermined frequency may be no more than 5 kHz.

This provides a suitable range for modifying the frequency during the pulse width modulation strategy to maximize a dimming, without providing any significant impact on control schemes for the individual light emitting module(s).

As a suitable working example, the predetermined frequency may be equal to 1 kHz.

The frequency control strategy also comprises controlling, for each cycle of the pulse width modulation, the length of the first period of time and the second period of time to thereby control the average current available to be drawn by each light emitting module. In particular, for increasing dimming levels, the length of the first period of time is reduced and the length of the second period of time is correspondingly increased. Similarly, for decreasing dimming levels, the length of the first period of time is increased and the length of the second period of time is correspondingly decreased.

As with the pulse width modulation strategy, during the frequency control strategy the maximum amplitude of current available to be drawn by the one or more light emitting modules may be fixed. In particular, the maximum amplitude of current available to be drawn by the one or more light emitting modules may be fixed to the lowest maximum amplitude for the current during the amplitude control strategy (i.e. the maximum amplitude for available current at the first predetermined dimming level TH₁).

Operating according to the frequency control strategy causes the resolution (e.g., color and/or temperature accuracy) of the light emitting arrangement to decrease.

However, it is advantageously recognized that this is of less importance at high dimming levels due to reduced perception of the human eye to changes at high dimming levels.

For the sake of completeness, FIG. 3 is a flowchart illustrating a method 300 that could be employed by the dimming control system to carry out the second control scheme.

The method 300 comprises a step 310 of obtaining a desired dimming level.

This may be obtained at an input interface of the dimming control system, e.g., receiving an input from a user interface and/or a communication module.

The method 300 then determines in a step 320 whether or not the desired dimming level falls within the first dimming range, i.e., falls between a minimum dimming level MIN and a first predetermined dimming level TH₁ (inclusive).

Responsive to the desired dimming level falling within the first dimming range, the method performs a step 330 of controlling the light emitting arrangement according to the amplitude control strategy.

Otherwise, the method performs a step 340 of determining whether or not the desired dimming level falls within the second dimming range, i.e., falls between the first predetermined dimming level TH₁ and a second predetermined dimming level TH2 (inclusive).

Responsive to the desired dimming level falling within the second dimming range, the method performs a step 350 of controlling the light emitting arrangement according to the pulse width modulation strategy. Otherwise, the method moves to a step 360 of controlling the light emitting arrangement according to the frequency control strategy.

For yet further improved understanding, FIGS. 4 and 5 illustrate a dimming procedure for the light emitting arrangement according to herein proposed concepts. Both Figs. demonstrate the average current I̅_̅{̅P̅W̅R̅}̅ (y-axis) available to be drawn by the light emitting module(s) (“average available current”) over time t (x-axis). The average available current is inversely proportional to the dimming level.

FIG. 4 demonstrates the average available current I̅_̅{̅P̅W̅R̅}̅ during the first control scheme as dimming level increases from a minimum dimming level at time t₁ (and therefore maximum average current) to a maximum dimming level at time t3. When the dimming level reaches a first predetermined dimming level TH1 at a time t2, the average available current I̅_̅{̅P̅W̅R̅}̅ reaches a first predetermined value I_{TH1}.

In the time period between times t₁ and t₂, when the average available current is between a maximum value I_{MAX} and the first predetermined value I_{TH1}, the dimming control system operates according to the amplitude control strategy. In the time period between times t₂ and t₃, when the average available current is between the first predetermined value I_{TH1} and a minimum value I_{MIN} (e.g., 0), the dimming control system operates according to the pulse width modulation strategy.

FIG. 5 demonstrates the average current I̅_̅{̅P̅W̅R̅}̅ during the second control scheme as dimming level increases from a minimum dimming level at time t₄ to a maximum dimming level at time t₇, and therefore the average available current decreases from a maximum available current I_{MAX} to a minimum available current I_{MIN}. When the dimming level reaches a first predetermined dimming level TH1 at a time t₅, the average current average current I̅_̅{̅P̅W̅R̅}̅ reaches a first predetermined value I_{TH1}. When the dimming level reaches a second predetermined dimming level TH2 at a time t₆, the average current average current I̅_̅{̅P̅W̅R̅}̅ reaches a second predetermined value I_{TH2}.

In the time period between times t₄ and t₅, when the average available current is between a maximum value I_{MAX} and the first predetermined value I_{TH1}, the dimming control system operates according to the amplitude control strategy. In the time period between times t₅ and t₆, when the average available current is between the first predetermined value I_{TH1} and the second predetermined value I_{TH2}, the dimming control system operates according to the pulse width modulation strategy, In the time period between times t₆ and t₇, when the average available current is between the second predetermined value I_{TH2} and a minimum value I_{MIN} (e.g., 0), the dimming control system operates according to the frequency control strategy.

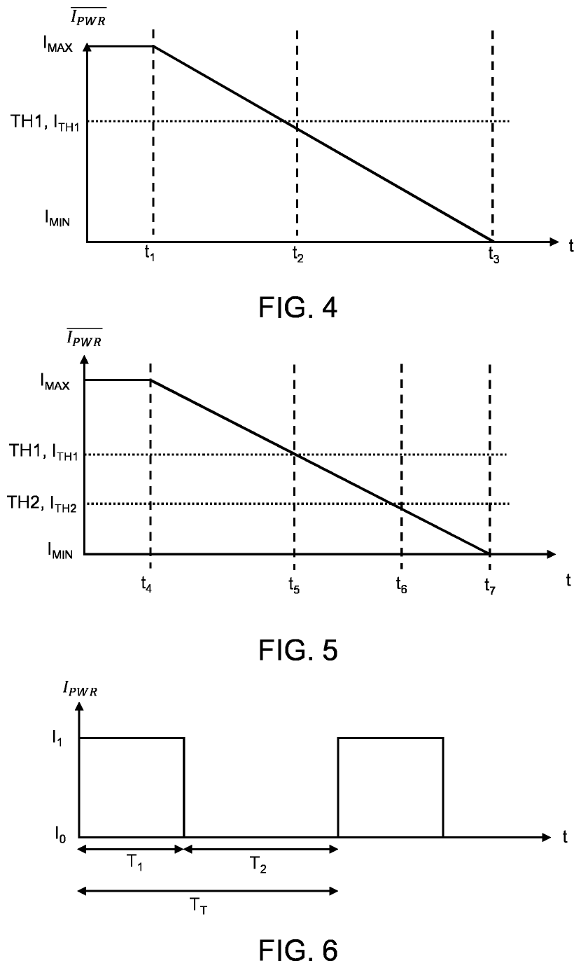

For yet further improved understanding, FIG. 6 illustrates the current I_{PWR} available to be drawn by the light emitting module(s) (“available current”) during a pulse width modulation strategy or the frequency control strategy. The available current is to be distinguished from the average available current.

The available current I_{PWR} is controlled, during the pulse width modulation strategy or the frequency control strategy, to alternate between a non-zero current value I₁ and a near-zero or zero current value I₀, i.e. undergo pulse width modulation.

In particular, both strategies comprises performing a series of cycles having a total length (of time) T_{T}. Each cycle is formed of a first period of time T₁ and a second period of time T₂.

During the first period of time T₁, the dimming control system allows current to be drawn by the one or more light emitting modules, i.e., the available current I_{PWR} is non-zero, e.g. the non-zero current value I₁.

During the second period of time T₂, the dimming control system allows current to be drawn by the one or more light emitting modules, i.e., the available current is zero or near zero, e.g. the near-zero or zero current value I₀.

For the pulse width modulation strategy, the first period of time T₁ is fixed to a same predetermined length of time for each cycle T_{T}. In this strategy, the length of the second period of time T₂ is controlled to control or change the average current available to be drawn by each light emitting module. Thus, the total length of the cycle T_{T} may change.

For the pulse width modulation strategy, the total length of the cycle T_{T} is fixed. In this strategy, the length of the first period of time T₁, and therefore the second period of time T₂, is controlled to control or change the average current available to be drawn by each light emitting module.

Turning back to FIG. 1, further optional features of the lighting arrangement 100 are illustrated.

In particular, the lighting arrangement 100 may comprise a smoothing capacitor C5, connected in parallel to the one or more light emitting modules. The smoothing capacitor acts to smooth a signal provided to the lighting arrangement, e.g., from a power source.

The lighting arrangement 100 may also comprise an input impedance R1.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

1. A dimming control system for controlling a dimming level of a light emitting arrangement comprising one or more light emitting modules, wherein:
a dimming level defines an average current available to be drawn by the one or more light emitting modules and ranges from a minimum dimming level to a maximum dimming level, in which a minimum dimming level provides a greater average current available to be drawn by the light emitting modules than the maximum dimming level;
for each light emitting module, the average intensity of light output by the light emitting module is responsive to an average current drawn by each light emitting module;
the dimming control system is configured to control the dimming level by:
for a first dimming range, which is bound by the minimum dimming level and a first predetermined dimming level, controlling the maximum amplitude of current available to be drawn by the one or more light emitting modules;
for a second dimming range, which is bound on one side by the first predetermined dimming level, performing pulse width modulation of the current available to be drawn by the one or more light emitting modules, wherein performing pulse width modulation comprises iteratively performing cycles, each cycle including:
a first period of time during which the dimming control system allows current to be drawn by the one or more light emitting modules, wherein the first period of time is fixed to a same predetermined length of time for each cycle;
a second period of time during which the dimming control system prevents or restricts current from being drawn by the one or more light emitting modules, wherein, for each cycle, the dimming control system controls the length of the second period of time to control the average current available to be drawn by each light emitting module,
wherein light output by the light emitting arrangement has a greater average intensity in the first dimming range than in the second dimming range.

2. The dimming control system of claim 1, wherein the dimming control system is configured to control the dimming level by, for a third dimming range:
maintaining the frequency of performing cycles of the pulse width modulation at a predetermined frequency; and
controlling, for each cycle of the pulse width modulation, the length of the first period of time and the second period of time to thereby control the average current available to be drawn by each light emitting module,
wherein the second dimming range is bound by the first predetermined dimming level and a second predetermined dimming level and the third dimming range is bound by the second predetermined dimming level and the maximum dimming level.

3. The dimming control system of claim 2, wherein the predetermined frequency is between 0.5 kHz and 5 kHz.

4. The dimming control system of claim 1, wherein the minimum frequency of performing cycles of the pulse width modulation during the second dimming range is no less than the predetermined frequency.

5. The dimming control system of claim 1, wherein the predetermined length of time is between 5 μs and 50 μs.

6. The dimming control system of claim 5, wherein the predetermined length of time is 25 μs.

7. The dimming control system of claim 1, wherein the dimming control system is configured to prevent or restrict current from being drawn by the one or more light emitting modules by activating a bypass switch that, when activated, provides a conductive path for current to bypass the one or more light emitting modules.

8. The dimming control system of claim 1, wherein the dimming control system is configured to prevent or restrict current from being drawn by the one or more light emitting modules by activating an isolating switch that, when activated, isolates or disconnects the one or more light emitting modules from a power supply configured to provide current to the one or more light emitting modules.

9. The dimming control system of claim 1, wherein:
the light emitting arrangement comprises a buck converter configured to provide current to the one or more light emitting modules; and
for the first dimming range, the dimming control system controls the operation of the buck converter to thereby control the maximum amplitude of current available to be drawn by the one or more light emitting modules.

10. The dimming control system of claim 9, for the first dimming range, the dimming control system, performs hysteretic control of the buck converter.

11. The dimming control system of claim 1, wherein the dimming control system is configured to:
receive a user input indicating a desired dimming level for the light emitting arrangement; and
control the dimming level responsive to the desired dimming level.

12. A lighting arrangement comprising:
the dimming control system of claim 1; and
the light emitting arrangement comprising the one or more light emitting modules.

13. The lighting arrangement of claim 12, wherein each light emitting module comprises:
one or more light emitting diodes connected in series;
a capacitor connected in parallel with the one or more light emitting diodes; and
a diode connected in series with the one or more light emitting diodes and the capacitor, wherein the diode is arranged to have an opposite polarity to the one or more light emitting diodes.

14. The lighting arrangement of claim 12, wherein each light emitting module comprises a module switch configured to control an average current drawn by the light emitting module.

15. The lighting arrangement of claim 12, wherein the one or more light emitting modules comprises a plurality of light emitting modules, and each light emitting module is configured to emit light of a different color and/or temperature.
